(19) United States
(12) Patent Application Publication
(10) Pub. No.: US 2013/0008997 A1
(43) Pub. Date: Jan. 10, 2013

(54) COMBINATION GROUND VEHICLE AND HELICOPTER AND FIXED WING AIRCRAFT

(76) Inventor: Francis X. Gentile, Los Angeles, CA (US)

(21) Appl. No.: 13/636,692

(22) PCT Filed: Mar. 24, 2011
(86) PCT No.: PCT/US11/29885

§ 371 Date: Sep. 23, 2012

Related U.S. Application Data
(60) Provisional application No. 61/316,850, filed on Mar. 24, 2010.

(51) Int. Cl. B64C 37/00; B60F 5/02; B64C 27/04

(52) U.S. Cl. 244/2

(57) ABSTRACT

A Combination Ground Vehicle and Helicopter and Fixed Wing Aircraft. A sideways translating tailsitter aircraft.

This application claims the benefit of PPA Ser. No. 61/316,850 filed 2010 Mar. 24 by the present Inventor, which is incorporated by reference.

### BRIEF DESCRIPTION OF THE SEVERAL VIEW OF THE DRAWINGS

FIG. 1. The aircraft viewed from above and ¾ view to the side of the wing 8, flying away from the viewer to the Northwest.

FIG. 2. The aircraft from the side of the wing during airplane type flight to illustrate the rearward extension of wheels parallel with the airflow to accomplish stabilization.

FIG. 3. The aircraft from the wing borne side during helicopter type flight which is the helicopters front or back, with the wheels in an orientation that may encourage rotor antitorque downwash airflow.

FIG. 4. The aircraft from the wing borne side in road going vehicle mode with the two bladed propeller in the stopped position pointing for and aft, and the wheels in a position where the center of gravity is lowered.

FIG. 5. The aircraft in road going mode viewed from the vehicle side going down hill, with linkages that allow the vehicle to be towed or to tow other vehicles.

FIG. 6. The wing borne side view of the aircraft and the helicopters and ground vehicles front or back with superimposed images of an occupant in the two primary positions of the occupants during aircraft which is facing the propeller and upside-down and sideways which is the helicopter and vehicle mode of flight.

FIG. 7. The wing borne side view of the aircraft where the possible rudder locations are shown, one rudder formed by the adjustable suspension struts, and another rudder formed by one sand paddle on the wheel used as a rudder by controlling the rotational position of the wheel.

FIG. 8. The wing borne above or below view of the wingborne aircraft or the side view of the vehicle where the wing has been swept to accomplish higher wingborne aircraft speeds and to avoid proximity to mines or explosives place in the roadway.

FIG. 9. Looking at the leading edge of the wing, reaction jet antitorque combined with leading edge heating and instrument sensor anti-ice heating.

FIG. 10. Looking from the side of the wing, Reaction Jet antitorque combined with leading edge heating and instrument sensor anti-ice heating.

FIG. 11. Looking at the leading edge of the wing, Circulation control antitorque combined with leading edge heating and instrument sensor anti-ice heating.

FIG. 12. Looking from the side of the wing, Circulation control antitorque combined with leading edge heating and instrument sensor anti-ice heating.

FIG. 13. Looking from the side of the wing while the aircraft is in wingborne mode in a rolling takeoff or landing while the aircraft is tilted to a more streamwise angle of attack.

FIG. 14 Looking at the planform of the wing with the leading edge facing upwards to illustrate a semicircular retreating edge planform which for low aspect ration wings is known to decrease wing stalling at high angles of attack associated with tilt wing and tailsitter transitional flight vertical and wingborne modes.

FIG. 15 An illustration of an example single wheel with a fairing or wheel pant which is rotated into a position for road going mode operation.

This wheel pant can be rotated to become a streamwise fairing and tail for wingborne operation.

FIG. 16 The wing borne side view of the aircraft where the possible rudder locations are shown, one rudder formed by a single suspension struts, and another rudder formed by one sand paddle on the wheel used as a rudder by controlling the rotational position of the wheel.

FIG. 17

Side view of a wheel with the first 25% to 50% of the wheel absent and open to allow air passage thru the wheel and to center or balance the aerodynamic force of the wheel as control surface near to the axle during the wheels action as an lifting control surface.

FIG. 18

Side view of a wheel with a hub with a single bar combination hub and twisted propeller, which can be used as a control surface.

FIG. 19

Side view of powered hub cap propeller generating anti torque thrust thru a static hub of the wheel even when the wheel is not rotating while resting on the earth.

FIG. 20

Side view of anti-torque propeller blades are integrated to become the wheel hub structure and simultaneous sand paddles and aerodynamic fins.

FIG. 21

View from above of sand paddle fins illustrating how the paddle 22 could be angled differently than 90 degrees to the wheel to act as a propeller blade and a sand paddle while illustrating also the top view of FIG. 20.

### DRAWINGS-REFERENCE NUMERALS

1 Wheel
2 Wheel
3 Wheel
4 Wheel
5 Struts
5b Struts with fin fairing
6 Struts
6b Struts with fin fairing
7 Struts
8 Wing Body Skin
9 Window on end of wing
10 Window as skin of wing body
11 Window as skin of wing body
12 Motor-Gearbox Nacelle
13 Trailing edge of wing
14 Leading Edge of Wing
15 Rotor Blade
16 Rotor Blade
17 Rotor Hub
18
19 Proppelor Hubcap
20 Fan Spoke, Sand Paddle, Air Fin on Wheel
21 Wheel Pants-Fairing
22 Sand Paddle, Air Fin on Wheel
23 Wheel Hub
24 Engine Exhaust Pipe
25 Circulation Control slots in pipe
26 Asymmetrical Tire
27 Single Articulated Bar Suspension Fin Strut
28 Single Un Articulated fixed Fin strut
29
30
31 Pilot in Ground and Helicopter mode
32 Pilot in Wingborne Flight mode

Types of prior art that have occurred:

Straight Wings beneath helicopter rotors, as anti-torque:

1930 Hafner R-2

1939 Sikorsky VS-300

1944 Doblhoff-2

Tilt Wing development aircraft:

1956 VZ-2

1959 X-18

1965 XC-142

1966 CL-84

Tail Sitters as non articulated fuselage and wing combinations:

a. Zimmerman Patent, Vought flying pancake aircraft articulated rotors capable of vertical translation although the craft was not equipped with a vertical landing gear.

b. Lockheed XFV-1 Salmon

c. Convair XFY-1 Pogo

A tail sitting aircraft made up of a wing alone known as “a flying wing” is;

1. the prior art of tilt wings in vertical mode without the combination of a hinged fuselage,

2. or a helicopter with the prior art antitorque wing below it,

3. or a wing with tail tailsitter without the combination of a tail.

The prior art above includes differential cyclic controls and schemes to maintain control while in the vertical mode of flight, that are further disclosed in other applications for tilt rotors and tandem, coaxial and single rotor helicopters. Candair CL-84, US MV22 Osprey, Vertol Model 76 or VZ-2, Hiller X-18, US XC-142A.

Circulation control and Reaction Jet antitorque is also well described in helicopter prior art.

A tailsitter with wing tip antitorque rotors on both sides is also described in patents. Such an embodiment has the advantage of redundancy and operator skill reduction as it avoids difficulty of estimating wind speed and direction to avoid loss of tail rotor effectiveness from main rotor vortex interference.

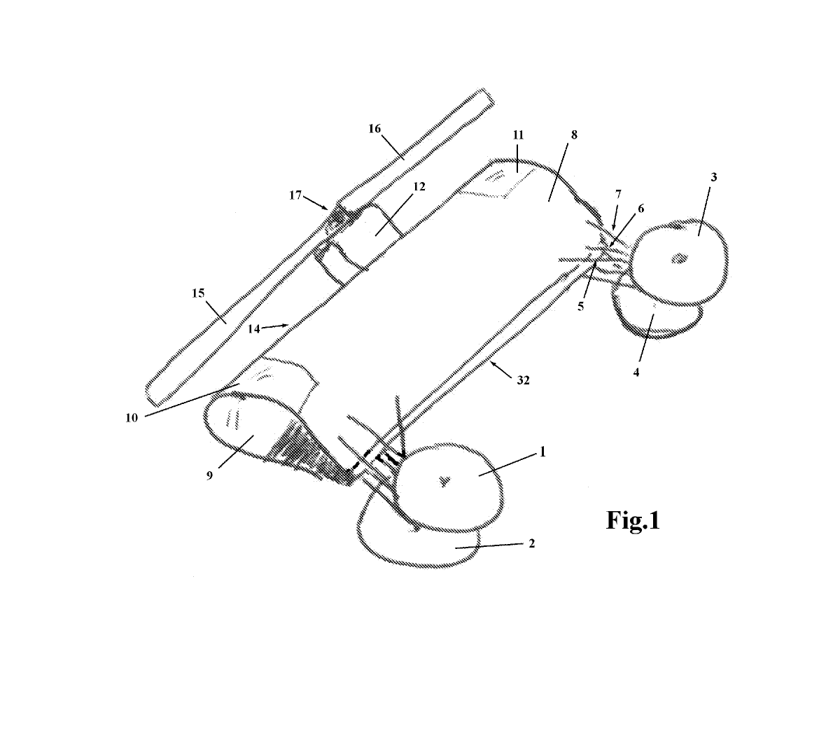

An embodiment of this invention could be described as a sideways translating tailsitter aircraft. FIG. 1

The aircraft viewed from above and ¾ view FIG. 1 to the side of the wing 8, flying away from the viewer to the Northwest with a leading edge 14 and the trailing edge 13, so as to illustrate the function of the wheels 1,2,3,4 as stabilizing surfaces, accomplishing rudder control with differential drag inducing action.

Also illustrated are pilot windows 9,10,11. Example adjustable suspension struts 5, 6, 7 are highlighted. The motor and transmission housing is at 12. One of two blades is 15, hub 17, and second blade at 16.

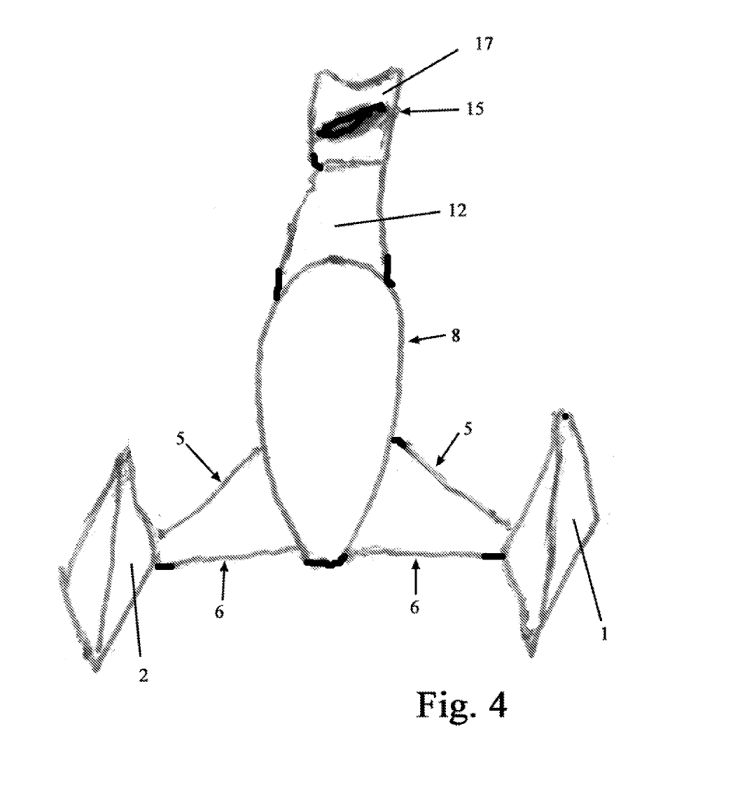

A two bladed propeller and helicopter rotor or two such proprotors acting coaxially would allow helicopter type control in vertical flight and the ability to function in forward flight as a propeller. Yet the rotor can be stowed by simply stopping it while pointed in the direction of travel FIG. 4, 5. The two bladed rotor can be stowed along the length of the vehicle during ground operations. The amount of rotor overhang is a balance between the effectiveness of counter torque choices and roadgoing practicality of length. There is an opportunity to reduce the disk loading enough to allow autorotation. Lowered disk loading will increase desirable tailsitter tiltwing translational lift. Excess power could allow a high top speed when the helicopter fuselage on its side becomes a wing.

Some of the goals accomplished by the embodiments are:

1. There are as few circles of air as possible thrown down to send the aircraft upward. Just one is accomplished.

2. Those thrown down circles of air are moving as slowly as possible. The rotor diameter is large in proportion the fuselage.

3. Structural parts are used for as many simultaneous purposes as possible, so that the structure and engine/fuel combination can be as lightweight as possible. The loading and fatigue spectra of conventional rolling land vehicles is rapidly destructive to aircraft weight structures. A pressurized monolithic semi-cylindrical structure 8 allows operation at altitudes where the speed/rang advantage of fixed wing flight over a helicopters occurs. Ground armor for military use is assisted by a monolithic shape 8 which presents as little flat surface to the ground as possible. Monolithic in the sense of being manufacturable in as few separate pieces as possible 8. In one embodiment Shaped Ceramic armor can act as the monolithic wing structure 8.

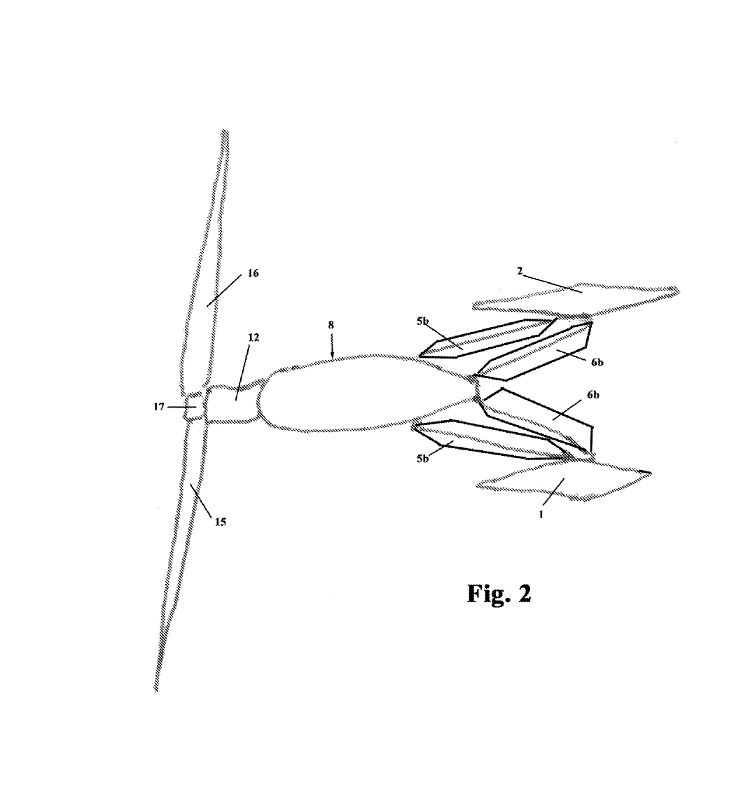

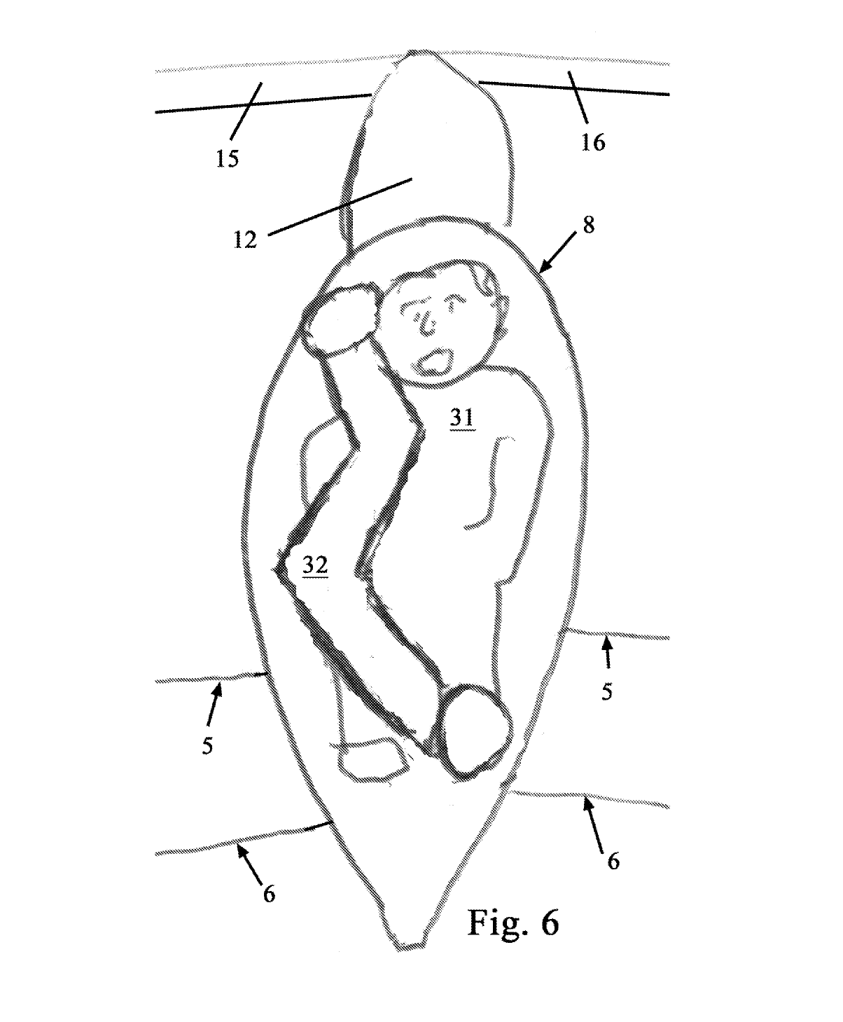

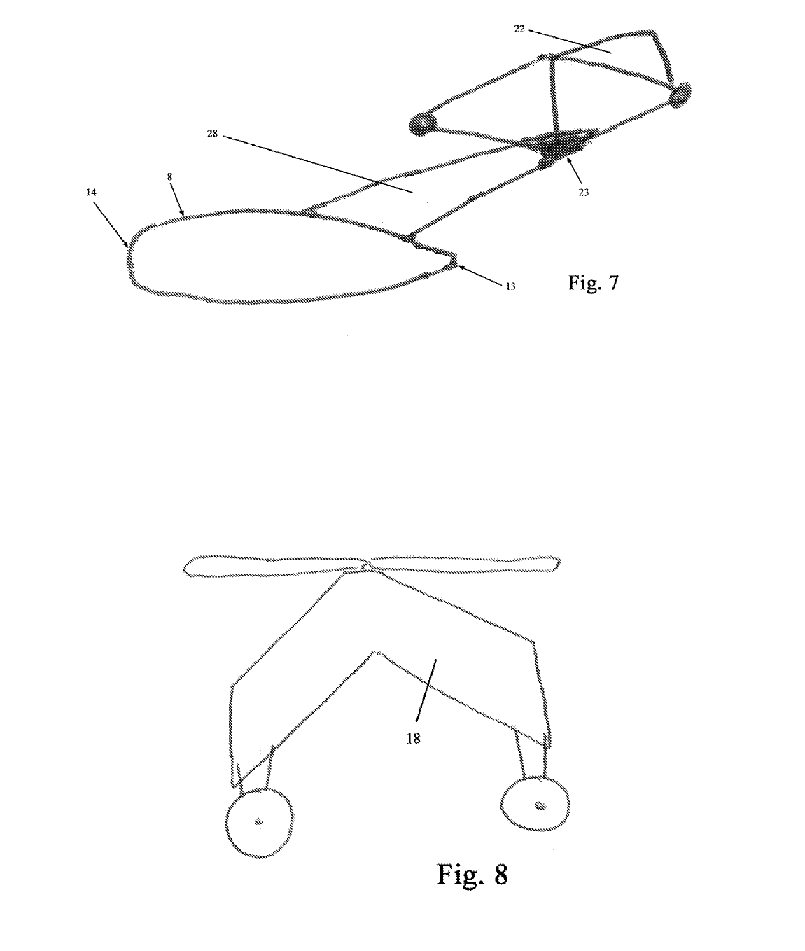

4. Soft Balloon Tires Invite ground resonance tip over accidents. Large diameter thin tires offer a larger contact patch in a harder tire that gives a smoother ride over rough terrain FIG. 4 items 1,2,3,4. An aerodynamic control surface is also formed by the large diameter wheel and tire FIG. 2, 3, 7. An embodiment of a special solution for deep sand is a fixed or pop out paddle FIG. 7 item 22. In one embodiment this attachment can be both paddle and aerodynamic surface with one paddle FIG. 7 item 22 item.

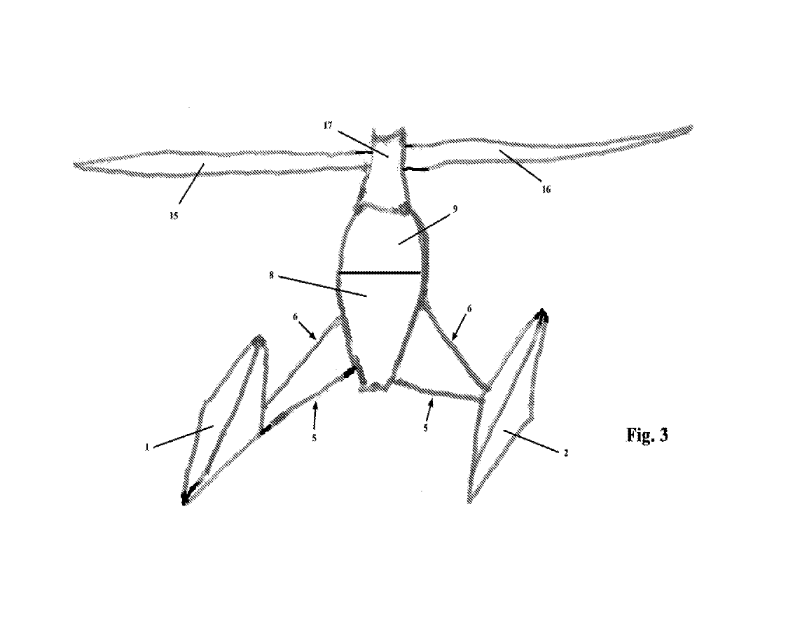

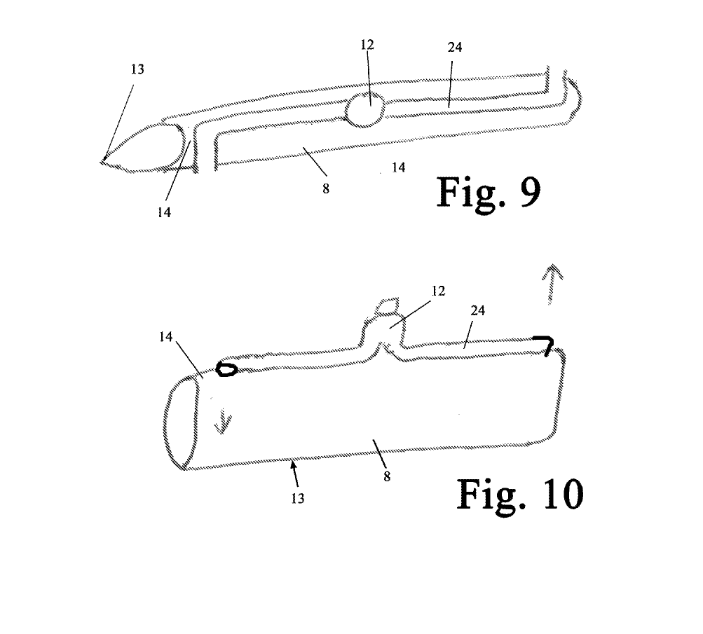

5. The best rotor power shaft solution is no cross shafts at all, not even for a tail rotor. Bulk counter torque comes from the long symmetrical section wing fuselage shape which is impacted with angled rotor swirl to accomplish counter torque as demonstrated by the hovering of large scale fixed wing model aircraft. Exhaust pipe item 24 jet force and circulation control exhaust slots 25 with or without fan driven airflow can assist and control counter torque FIG. 9, 10, 11, 12 items 24,25. Fine control can be accomplished by the variable length suspension arms of the aerodynamic surface road wheels which tilt the wheels within the rotor slipstream FIG. 3 items 5, 6, 5a, 5b, 27, 28. Tall wheels fore and aft act as tails in wing borne flight by varying the length and/or angular tilt of suspension wishbones FIG. 1, 2, 7 item 5, 6, 5a, 5b, 27, 28. The larger the wheel diameter allows a smoother ground ride, and better grip and lower rolling resistance.

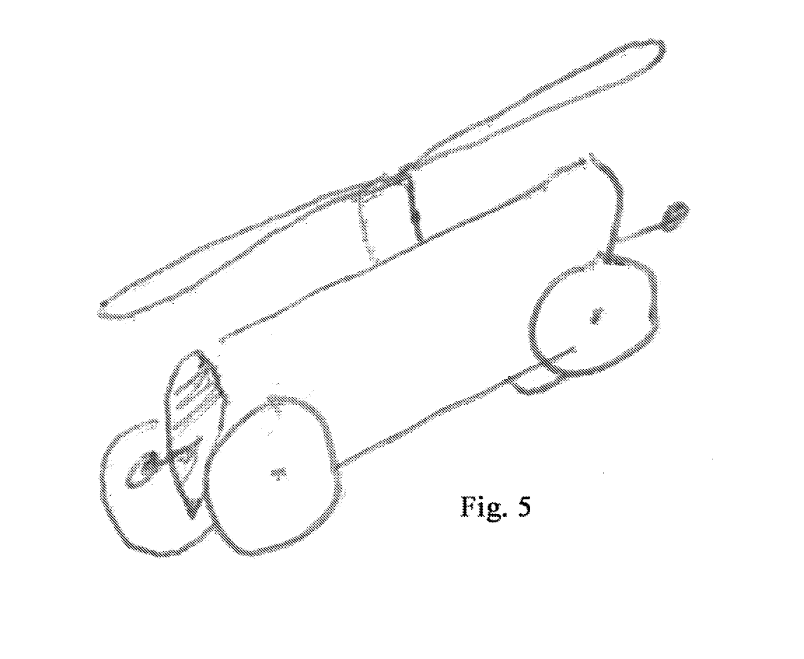

Either end of the vehicle has an asexual remote latching towing receptacle allowing swift routine rescues and energy saving train style towing. The vehicle can be driven from either end in either direction, avoiding the clumsy turnaround under fire (FIG. 5). Such an location could also be the location for dual wingtip tail rotors.

It is economical for existing helicopter and tiltrotor powerplant rotor combinations to be used. The vehicle will have a high rolling center of gravity when the motor is on top which also necessary to have a stable forward center of gravity during horizontal wingborne flight. The suspension struts 5, 6, 5a, 5b can change length to widen the track for ground stability. Splay and squat and kneel is available as an additional unexpected benefit of the adjustable suspension configuration.

A squared off flat trailing airfoil edge has been shown have good aerodynamic performance, therefore the bottom of the vehicle can be strong against rocks. Improvised explosive devices and mines build up pressure under the vehicle. A sharp trailing edge embodiment of the wing may have some slight advantage in deflecting blasts. Overall the wing shape presents armor is at its most efficient against ground explosives from below (FIG. 4). An embodiment of a faceted wing sectional shape would improve performance of most armor against projectiles and blasts from all directions. It has been shown that faceted sectional shapes can perform reasonably well aerodynamically in early supersonic wing shape windtunnel tests which considered diamond wedge shaped wing sections. Later subsonic aircraft such as the F117 were able to use the facets to limit radar detection.

In one embodiment ground wheels propulsion by cogged belts are proposed. The proprotors engine shaft power takeoff point is used to power the ground wheels. In one embodiment a clutch and a rotor brake would be installed at the power take off point.

One embodiment places a large electrical generator on the power take off point to supply electrically powered road wheels and power to communication and electrical weaponry.

In another embodiment portable avionics allow the pilots to freely change their seating position and cockpit configuration to change between ground vehicle helicopter mode and wingborne aircraft flight mode. Seating change can be accomplished by relatching a harness or hammock style suspended seating FIG. 6 items 31,32.

Changes in seating position are a problem of tailsitter aircraft. The embodiment of portable avionics and harness latching has the unexpected benefit facilitating the operation of the aircraft in its both vertical and sideways change in the aircraft modes of flight and operation.

In another embodiment crash energy absorption is sewn into the operators harness latching system and a “padded cell” operators cabin that facilitates operator seating changes with the least structural weight and most comfort.

In another embodiment there is a pilot at both ends of the aircraft, to accommodate vision, direction change in confined conditions, battle damage redundancy and towing latching control in combat under fire FIG. 1. items 9,10,11.

In one embodiment, the arrangement of wheel/air control surfaces improves the simplicity of table look up control by reducing actuator mixing requirements (for example in other aircraft, V-tail is more complex that a cruciform tail). The lower wheel 2,4 in forward flight would act only as elevator (in one embodiment with a slight fixed dihedral tilt) Therefore the elevator angle of incidence can be displayed to the operator with symbols denoting the angles associated with desired Table Look up flight modes. The top wheel 1,3 in forward flight would be only for roll control, so its angle of incidence can likewise be displayed. This minimum of mixing across control surfaces facilitates table look up.

In one embodiment that the function of vertical tails could be accomplished in a third surface that has a dual use. One or more sand wheel paddles could act as vertical tails or fins by rotating the tire which contains fixed fins or paddles using the already existing ground drive system FIG. 7 item 22.

In another embodiment the suspension arms could be used as vertical tail structure with appropriate fairings FIG. 2 item 5a,5b.

Two of the suspension arms may be in line with wingborne airflow. This is ideal to reduce actuator mixing, a single suspension arm length changing actuator could affect a change of the wheel surface angle perpendicular or parallel to the wing. Therefore the actuator position control could be calibrated with angle of incidence and therefore the associated Table look up flight mode desired. Three variable length suspension arms are perhaps the minimum to fulfill all purposes without rotational actuation at the attachment ends by costly low backlash gear systems. However four suspension arms would allow two to share slipstream air drag in all modes of flight if the wheel hub was wide enough to allow a square arrangement.

The more common rhombus triangulation would present the side of at least one or more arms to airflow.

Among the embodiments to change suspension length are: those associated with auto steering. i.e. worm and rack and pinion, jack screws and hydraulic cylinders.

An embodiment to avoid the phugoid oscillation is the symmetrical section straight wing which has a near constant center of pressure with changing angle of attack. The table look up method of flying is simplified and pilot induced oscillations are less likely. Autopilots are less likely to have their capabilities swamped and overcome by divergence. Ideally there would be the capability of flying by reference to main wing angle of attack alone without airspeed based dampening of a phugoid oscillation.

In another embodiment high mach speed would be facilitated with a swept wing configuration, and a supercritical airfoil FIG. 8. Rotor downwash would be asymmetric in counter torque, the planform and airfoil would have a moving center of pressure (pitching moment) which may require a sensor dependent automatic stabilization.

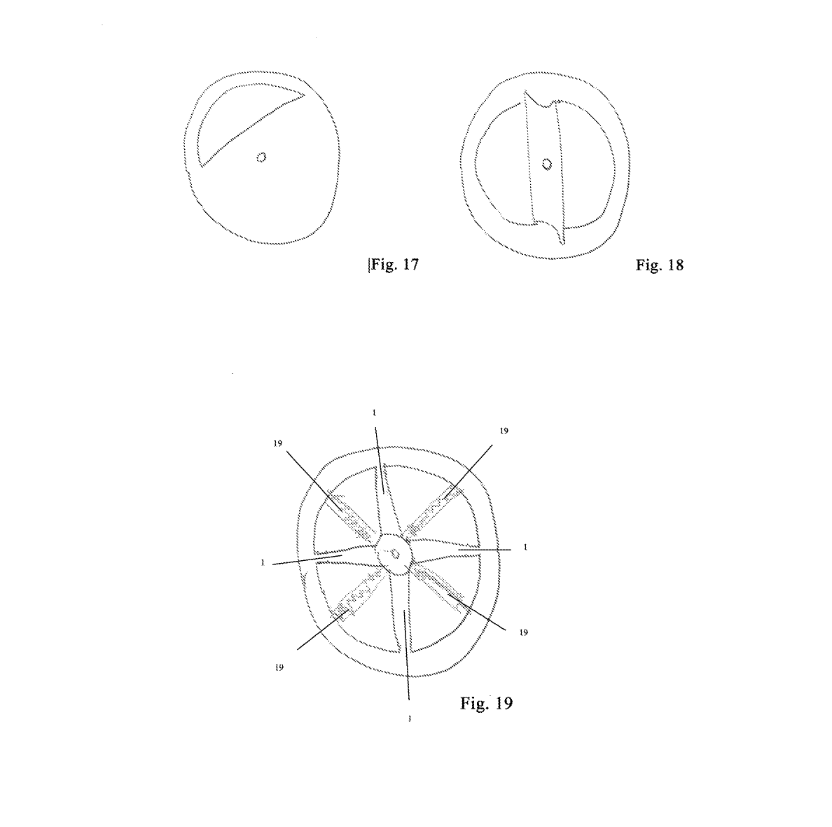

The control surface wheels are symmetrical, however the circle planform has a center of pressure that moves forward with increasing angle of attack which could contribute to some overshoot against good dampening of the circle rounded trailing edge. With the first 25% to 50% of the cone absent and open would allow air passage thru the wheel and to center or balance the aerodynamic force of the wheel as control surface near to the axle FIG. 17.

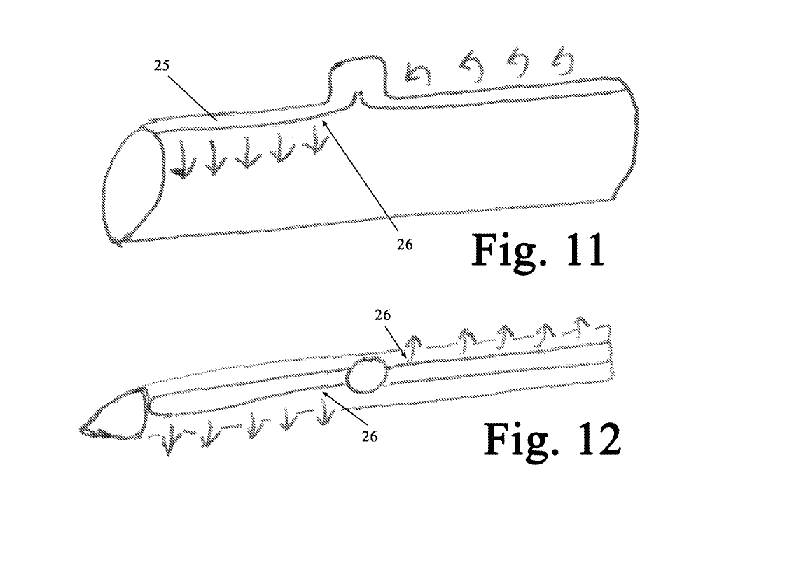

In an embodiment of anti rotor torque and anti-ice strategy and exhaust pipe routing, a stainless steel or titanium exhaust pipe wing leading edge appears feasible on the proposed configuration FIG. 9, 10, 11, 12 items 24,25, for always-on anti-ice on the main wing. Any ice sensitive sensor should made up of metal parts that conduct the heat of the exhaust from the exhaust heated leading edge exhaust pipe, i.e. Pressure ports, Pitot tubes, static ports, and AOA vanes. The heat is always on and the sensor won't burn, melt, ice up or collect condensation. The air originating in the engine exhaust that would be carried in pipes 24 to produce an anti torque force by wing blowing circulation control Coanda effect FIG. 11,12 item 25 or direct reaction jet blowing FIG. 9,10 item 24.

In summary a tail sitting flying wing with the wing as tailboom fuselage wing for helicopter mode downwash powered antitorque wing using a monolithic wing skin structure suitable for pressurization and land mine armor with the rear of wing pointed down to deflect forces from land mine explosions.

The vehicle 3 or 4 or more wheels some or all of which are articulated, by changing length of 2 or 3 or 4 suspension arms which are connected at 2 or 3 or 4 separated points on the wheel hub from and 2 or 3 or 4 separated points on the fuselage wing body. The length of the strut can be changed with hydraulics using variable orifice or viscosity dampening, springing, Integral springing and damping, screw jacks, Combined with springing and dampening.

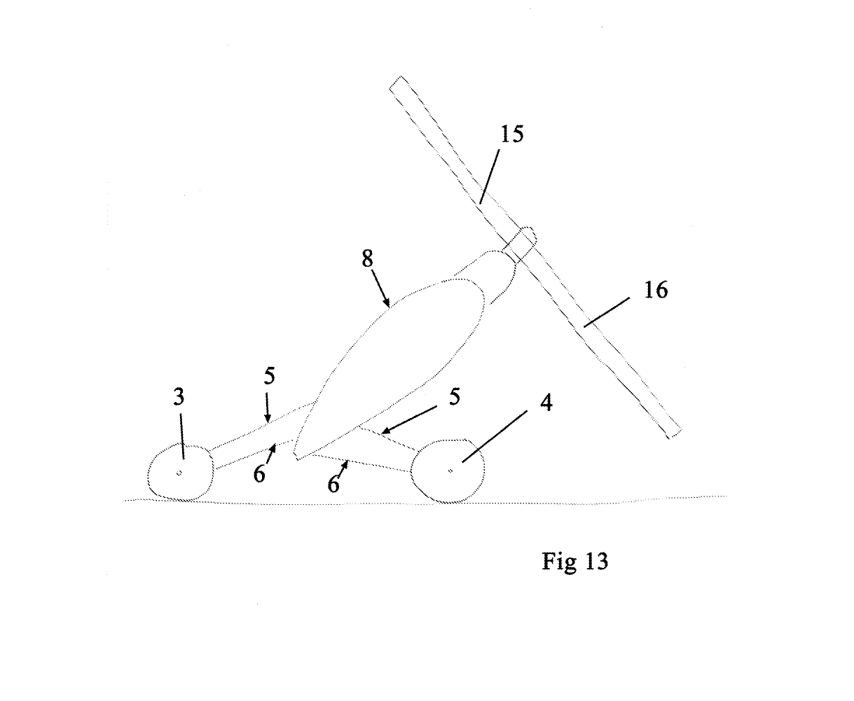

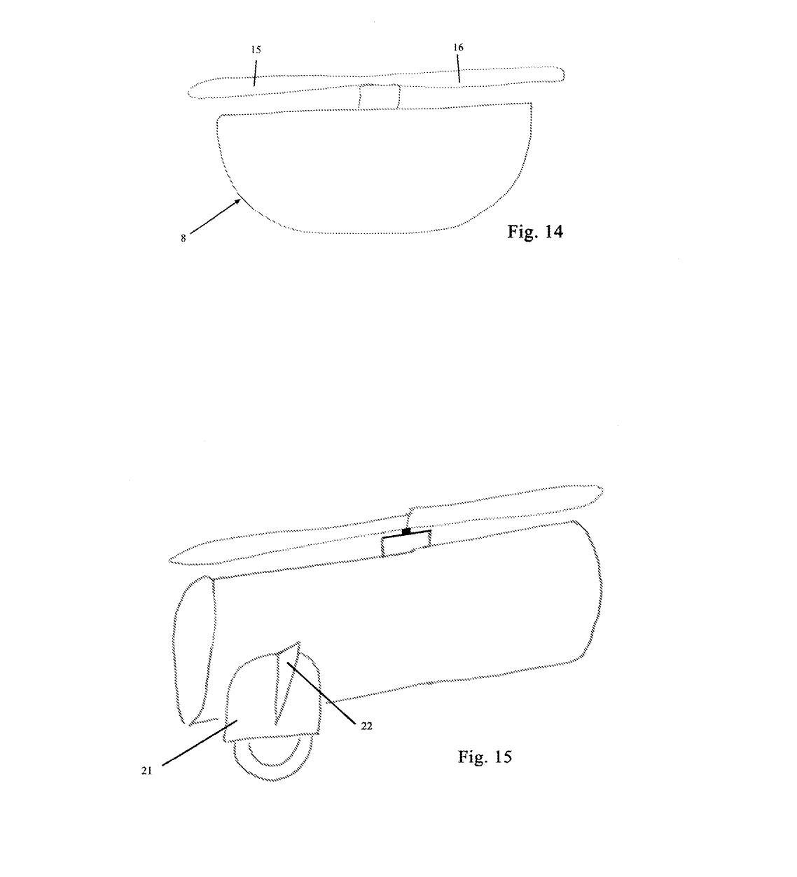

A vehicle Capable of rotating and steering the wheels forward as a ground vehicle and sideways as runway rolling wingborne aircraft. Capable of having one wheel acting as elevator FIG. 2 and the nearest adjacent wheel acting as a perpendicular rudder FIG. 13, 3.

In one embodiment steering of the wheel in all axis by short arms to the suspension arms or in other embodiments the steering of the wheel inside articulated wheel hubs having powered articulated axis of rotation using a planetary or resonant gearbox hub inset in and streamlined to wheel can be accomplished.

An embodiment could be capable of rotating and steering the wheels forward as a ground vehicle FIG. 4 and sideways as runway rolling wingborne aircraft FIG. 13.

There exists an embodiment of suspension Arms shaped to act as fin surfaces streamlined to the flow of the craft when in wingborne flight, Suspension arms fin fairings rotated to act as rudder control, Movable surfaces attached to the rear of the shaped fin to control as a rudder FIG. 2.

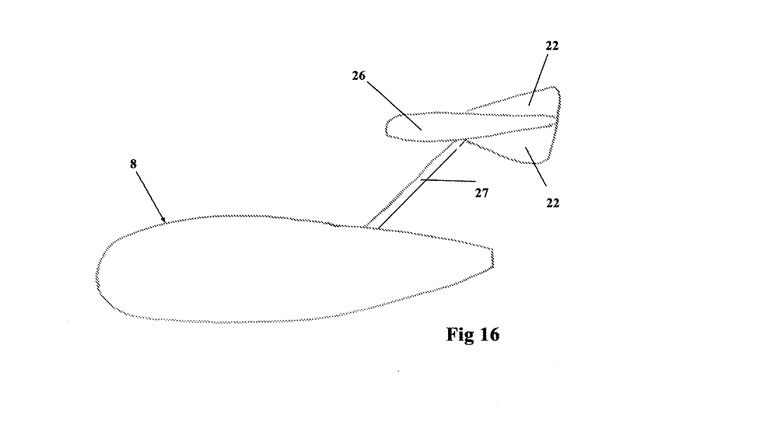

There exists another embodiment of conical wheel hubs wider than the tire for aero dynamic drag reduction and sand and water flotation. One or more paddles on the wheel which act as aerodynamic rudder or sand or water paddle propulsion FIG. 7, FIG. 16, 22. These conical hubs could be large enough for flotation of the aircraft.

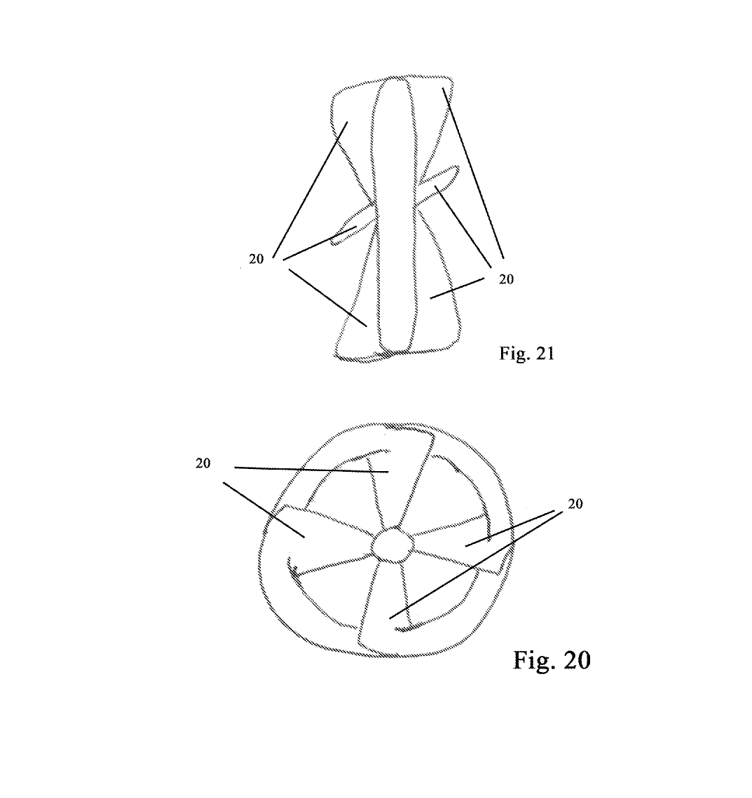

Another embodiment exists where the Wheel and rudder are moved to streamwise flow when the vehicle is in wingborne flight FIG. 7, 16. Paddles may be canted away from perpendicular to rotation of wheel to propel air for antitorque FIG. 21,22. Large diameter wheels in proportion to vehicle with thin tires.

An embodiment of an asymmetrical tire being thicker on one side and thinner on the other for aerodynamic drag reduction FIG. 16 item 26

Wheels Hubs may capable of acting as Helicopter mode antitorque rotors when spun by the same mechanism as vehicle rotation and capable of acting as control surfaces when in Wingborne mode flight FIG. 18, 20,21. Single twisted bar strut hub forming two bladed propeller when rotated

Or in another embodiment a proppelor hubcap can rotate separately from the vehicle wheel to act as a helicopter tail rotor FIG. 19, item 19.

An embodiment of sand paddles-air fins on both sides of the Wheel as stabilizing surfaces where the wheel is in in an elevator position so that the two sand paddle air fin surfaces surfaces are in the vertical orientation to accomplish rudder fin surfaces.

In another embodiment a solid single bar suspension strut is absorbing all loads with all articulation accomplished in the strut attachments in the fuselage and wheel hub FIG. 16, item 27.

A wheel pant or fairing over half of the wheel that can be independently rotated to allow rolling over ground and to rotate to the opposite position to act as a fairing and rudder to the wheel in wingborne flight. A fin can be attached to wheel pant or fairing to act as fin or rudder.

In one embodiment a low aspect ratio wing between 3 and 0.5 with a semicircular rear planform helps to eliminate wing stall elimination during translational flight.

I claim:

1. A sideways translating tail sitting flying wing and rolling ground vehicle comprising;
a) a wing as tailboom fuselage wing for Helicopter mode downwash powered Antitorque wing;
b) a monolithic wing skin structure suitable for pressurization and land mine armor;
c) rear of wing pointed down deflecting damage from land mines;
d) centered single two bladed rotor stopped parallel the wing when in ground vehicle mode;
e) sufficient disk size to vehicle weight to be capable of autorotation and excess thrust to survive translational flight main wing stall without loss of altitude;
d) 3 or 4 or more wheels articulated by changing the length of suspension arms connected to separated points on the wheel hub from separated points on the fuselage wing body;
e) or by changing the angle of attachment of a suspension arm at either end of the suspension arm;
f) suspension arms shaped to act as fin surfaces streamlined to the flow of the craft when in wingborne flight
g) suspension arms fin surfaces movably rotated to act as rudder control.
h) rotating and steering the wheels forward as a ground vehicle and sideways as runway rolling wingborne aircraft;
i) rotating and steering one wheel to act as elevator and the nearest adjacent wheel to act as a perpendicular rudder;
j) conical Wheel Hubs wider than the tire for aero dynamic drag reduction and sand and water flotation;
k) large diameter wheels in proportion to vehicle with thin tires.

2. The aircraft as in claim 1, comprising;
One or more paddles on the wheel which act as aerodynamic rudder or sand or water paddle propulsion, with the wheel and rudder locked to streamwise flow when the vehicle is in wingborne flight.

3. The aircraft as in claim 1, comprising;
a) One or more paddles on the wheel which act as aerodynamic rudder or sand or water paddle propulsion, with the wheel and rudder locked to streamwise flow when the vehicle is in wingborne flight;
b) and the paddles canted away from perpendicular to rotation of wheel to propel air as a tail rotor for antitorque when rotated by the same mechanism as vehicle propulsion.

4. The aircraft as in claim 1, comprising;
Tires thicker and hubs thicker on one side and thinner on the other for aerodynamic drag reduction when the thicker side of the tire wheel is oriented in the direction of wingborne flight.

5. The aircraft as in claim 1, comprising;
wheels with 25% to 50% of cone absent and open to allow air passage thru the wheel during wingborne forward flight to center and balance the aerodynamic force of the wheel as control surface near to the axle.

6. The aircraft as in claim 1, comprising;
wheel pants or fairing over half of the wheel that can be independently rotated to allow rolling over ground and to rotate to the opposite position to act as a fairing and rudder to the wheel in wingborne flight with a fin attached to wheel pant or fairing to act as fin or rudder.

7. The aircraft as in claim 1, comprising;
wheels hubs capable of acting as helicopter mode antitorque rotors with a single twisted bar strut hub forming a two bladed propeller when rotated by the same mechanism as vehicle propulsion and capable of acting as control surfaces when in Wingborne mode flight.

8. The aircraft as in claim 1, comprising;
a spoked wheel with a powered rotor hubcap which acts as antitorque tail rotor in helicopter mode whose rotation is independent from the ground vehicle wheel rotation propulsion.

9. The aircraft as in claim 1, comprising;
a flying wing in a low aspect ratio between 3 and 0.5 with a Semicircular rear planform for stall elimination during translational flight.

10. A method for transforming a vehicles wheel position to act as;
a) ground wheels for vehicle action in wing long direction;
b) rolling wing borne take off with wheels splayed to tilt the wing and steering of wheels in the direction perpendicular to the wing;
c) wheels as movable wings for helicopter mode downwash powered antitorque control paddles;
d) wheels spun as blowing rotors for anti torque control;
e) wheels as stabilizing and control surfaces for wing born flight.

11. A vehicle with a means for transforming between;
a) Rolling Ground Vehicle;
b) Helicopter;
c) Wingborne aircraft.
